(19) United States
(12) Patent Application Publication
(10) Pub. No.: US 2022/0327586 A1
(43) Pub. Date: Oct. 13, 2022

(54) OPINION SUMMARIZATION TOOL

(71) Applicant: NEC Laboratories America, Inc., Princeton, NJ (US)

(72) Inventor: Christopher Malon, Fort Lee, NJ (US)

(21) Appl. No.: 17/716,347

(22) Filed: Apr. 8, 2022

Related U.S. Application Data
(60) Provisional application No. 63/173,528, filed on Apr. 12, 2021.

(51) Int. Cl. G06Q 30/02; G06N 3/08; G06N 3/04

(52) U.S. Cl. CPC G06Q 30/0282; G06N 3/08; G06N 3/0454

(57) ABSTRACT

Systems and methods for opinion summarization are provided for extracting and counting frequent opinions. The method includes performing a frequency analysis on an inputted list of product reviews for a single item and an inputted corpus of reviews for a product category containing the single item to identify one or more frequent phrases; fine tuning a pretrained transformer model to produce a trained neural network claim generator model, and generating a trained neural network opposing claim generator model based on the trained neural network claim generator model. The method further includes generating a pair of opposing claims for each of the one or more frequent phrases, wherein a generated positive claim is entailed by the product reviews for the single item and a negative claim refutes the positive claim, and outputting a count of sentences entailing the positive claim and a count of sentences entailing the negative claim.

### RELATED APPLICATION INFORMATION

This application claims priority to U.S. Provisional Patent Application No. 63/173,528, filed on Apr. 12, 2021, and incorporated herein by reference in its entirety.

### BACKGROUND

### Technical Field

The present invention relates to extracting and counting frequent opinions and more particularly for extracting and counting frequent opinions within a corpus of customer reviews.

### Description of the Related Art

Capturing word embeddings from very large corpora increases the value of word embeddings to both unsupervised and semi-supervised NLP tasks. Bidirectional recurrent neural networks such as bidirectional LSTMs have been used to learn internal representations of wider sentential contexts. Context2Vec is a neural network model that embeds entire sentential contexts and target words in the same low-dimensional space. The model can learn a generic task-independent embedding function for variable-length sentential contexts around target words based on a continuous bag of words (CBOW) architecture.

Objective functions define the objective of the optimization. An optimization problem can be stated as: min(Φ(U(x),x)), where Φ is the objective function that depends on the state variables, U, and the design variables, x. The target of an objective function can be minimized or maximized.

### SUMMARY

According to an aspect of the present invention, a method is provided for extracting and counting frequent opinions. The method includes performing a frequency analysis on an inputted list of product reviews for a single item and an inputted corpus of reviews for a product category containing the single item to identify one or more frequent phrases. The method further includes fine tuning a pretrained transformer model to produce a trained neural network claim generator model, T¹, and generating a trained neural network opposing claim generator model based on the trained neural network claim generator model. The method further includes generating a pair of opposing claims for each of the one or more frequent phrases related to the product review using the trained neural network claim generator model and the trained neural network opposing claim generator model, wherein a generated positive claim is entailed by the product reviews for the single item and a negative claim refutes the positive claim, and outputting a count of sentences entailing the positive claim and a count of sentences entailing the negative claim.

According to another aspect of the present invention, a system is provided for opinion summarization. The system includes, one or more processors, computer memory, and a display screen in electronic communication with the computer memory and the one or more processors, wherein the computer memory includes a frequency analyzer configured to perform a frequency analysis on an inputted list of product reviews for a single item and an inputted corpus of reviews for a product category containing the single item to identify one or more frequent phrases, a trained neural network claim generator model, a trained neural network opposing claim generator model, wherein the trained neural network claim generator model and the trained neural network opposing claim generator model are configured to generate a pair of opposing claims for each of the one or more frequent phrases related to the product reviews, wherein a positive claim generated by the trained neural network claim generator is entailed by the product reviews for the single item and a negative claim generated by the trained neural network opposing claim generator refutes the positive claim, and an entailment module configured to output a count of sentences entailing the positive claim and a count of sentences entailing the negative claim.

According to yet another aspect of the present invention, non-transitory computer readable storage medium comprising a computer readable program for extracting and counting frequent opinions is provided. The computer readable program when executed on a computer causes the computer to perform the steps of: performing a frequency analysis on an inputted list of product reviews for a single item and an inputted corpus of reviews for a product category containing the single item to identify one or more frequent phrases; fine tuning a pretrained transformer model to produce a trained neural network claim generator model, T¹; generating a trained neural network opposing claim generator model based on the trained neural network claim generator model; generating a pair of opposing claims for each of the one or more frequent phrases related to the product review using the trained neural network claim generator model and the trained neural network opposing claim generator model, wherein a generated positive claim is entailed by the product reviews for the single item and a negative claim refutes the positive claim; and outputting a count of sentences entailing the positive claim and a count of sentences entailing the negative claim.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high-level system/method for summarizing opinions from customer reviews, in accordance with an embodiment of the present invention;

FIG. 2 is a block/flow diagram illustrating a system/method for applying a claim generator and opposing claim generator, in accordance with an embodiment of the present invention;

FIG. 3 is a flow diagram illustrating a system/method for training a claim generator, in accordance with an embodiment of the present invention;

FIG. 4 is a flow diagram illustrating a system/method for training an opposing claim generator, in accordance with an embodiment of the present invention;

FIG. 5 is a computer system for opinion summarization is illustrated, in accordance with an embodiment of the present invention; and

FIG. 6 is a block diagram of exemplary reviews and output, in accordance with an embodiment of the present invention.

### DETAILED DESCRIPTION OF PREFERRED EMBODIMENTS

In accordance with embodiments of the present invention, systems and methods are provided for extracting and counting frequent opinions within a corpus of customer reviews. Embodiments of the invention relate to summarizing and counting contrasting opinions about aspects of a product or service given by key words or phrases, within a set of customer reviews.

In various embodiments, a list of frequent phrases and sentences containing those phrases is determined by comparing frequencies in a collection of reviews about a single product to overall frequencies of the phrases in the corpus. For each phrase, a first generation module fills in a template with a word to write a sentence using the phrase. A second generation module writes an opposing sentence using the phrase. Sentences in the review corpus that semantically imply the first generated sentence or opposing generated sentence can be counted and extracted using an entailment module.

In various embodiments, statements are compared using an entailment module. This can allow diverse ways of describing an aspect of a product or service compared to keyword matching, and an opinion may be isolated with regard to an aspect, even if other opinions are contained in the same sentence.

Entailment is the classification task of predicting the logical relation between a pair of sentences. Given a pair (p, h) of a premise statement, p, and a hypothesis, h, a distribution is computed over the probabilities that p entails h, that p refutes h, or neither. In various embodiments, the method utilizes a trained entailment module, M, where M(p; h; r) predicts the logarithm of the probability that premise, p, and hypothesis, h, are in relation, r. After training, the parameters of the trained entailment module, M, are frozen for the subsequent steps.

In one or more embodiments, a trained entailment module, M, and a trained language model, T⁰, are used to train a claim generation module that generates fluent claims that are semantically implied by the review text. For each generated fluent claim, a semantically opposing claim is also generated to capture disagreements among the reviews.

In various embodiments, by using a claim generation module, one can pinpoint opinions about key phrases beyond just “positive” and “negative” sentiment. A pretrained transformer model for masked language modeling, such as Bidirectional Encoder Representations from Transformers (BERT) or XLNet, can be fine-tuned to become the claim generation model, where the fine-tuned claim generation model predicts the sequence of words for the claim. The vocabulary for such a model includes tokens for common words and pieces of words, and several special tokens used in training. Unannotated reviews can be used for training, without any ground truth summaries or ground truth sentiment data.

In various embodiments, the pairs of opposing claims are output to the user, along with counts and/or quotes of the original review statements that support each of the claims.

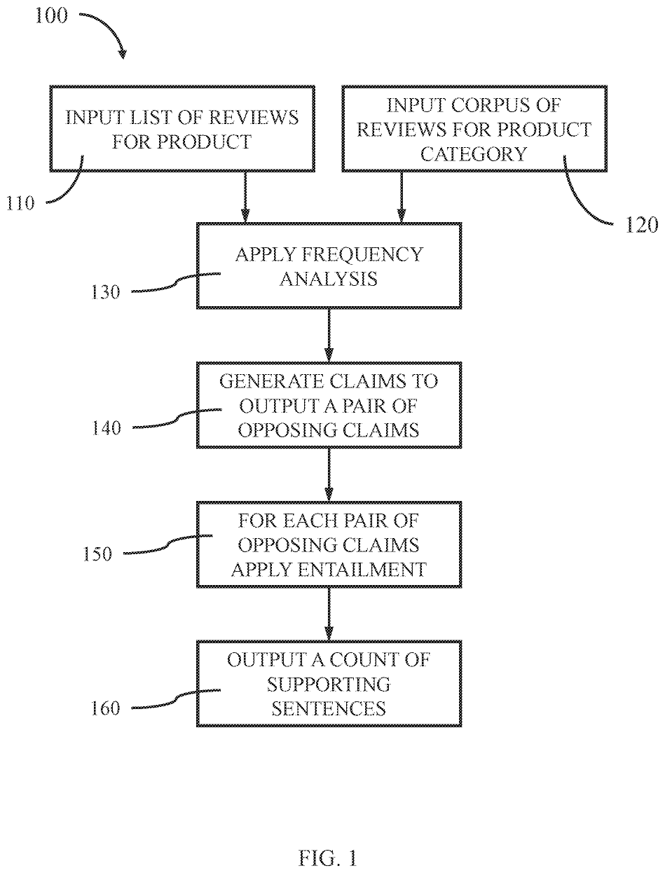

Referring now in detail to the figures in which like numerals represent the same or similar elements and initially to FIG. 1, a high-level system/method for summarizing opinions from customer reviews is described, in accordance with an embodiment of the present invention.

In one or more embodiments, an opinion summarization tool 100 can count opinions about a product and provide summaries of the opinions.

At block 110, a list of reviews of a single product can be inputted to the frequency analyzer of the opinion summarization tool 100.

At block 120, a corpus of reviews of a set of products in the same category as the single product can be inputted to the frequency analyzer of the opinion summarization tool 100.

At block 130, the frequency analyzer can perform frequency analysis on both the list of reviews of the single product and the corpus of reviews of the set of products in the same category. The frequency analysis can find frequent phrases for the single product, and identify key words and/or phrases, used in the list of reviews of the single product. The frequency analysis can also find the frequency of the phrases in the corpus. Given a set of reviews of a single product, a set of key words and/or phrases can be selected. The key words may be input directly by a user or determined, for example, by taking the phrases that occur in that product's reviews more frequently than in the review corpus overall by some factor.

At block 140, a claim generator may output a pair of opposing claims related to the single product, where a pair of opposing claims can be generated for each of the phrases that equal or exceed a threshold frequency. The claim, g, and opposing claim g′ are the output of the claim generator module.

At block 150, entailment can be applied to each claim of the opposing claims and the sentences of the reviews of the single product by an entailment module, M. In various embodiments, the method utilizes a trained entailment module, M, where M(p; h; r) predicts the logarithm of the probability that premise p and h are in relation r.

At block 160, pairs of opposing claims and a count and/or quotation of the sentences in the reviews that supported either of the opposing claims can be outputted to the user. To generate a summary for the user, the entailment module, M, is then applied against every sentence of reviews of the product. A count of sentences, x, such that:

argmaxᵣ M(x, g, r)=entails;

and a count of sentences, x, such that

argmaxᵣ M(x, g′, r)=entails;

is output to the user, along with the text of g and g′. This summarizes the contrasting opinions about key word or phrase, k.

Pairs of opposing claims involving the frequent phrases and a count or quotation of the sentences that supported them can be outputted.

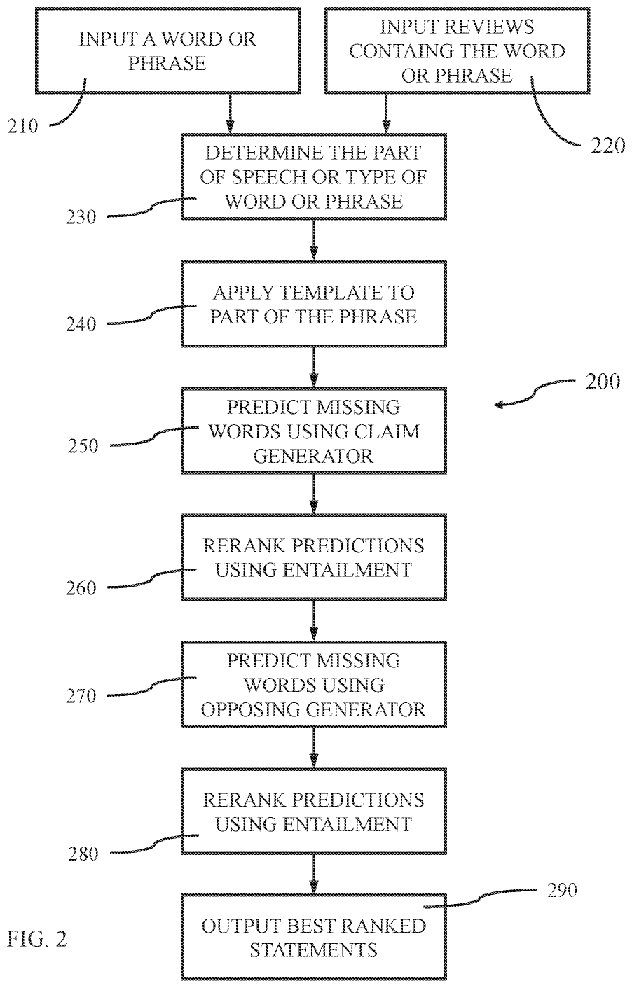

FIG. 2 is a block/flow diagram illustrating a system/method for applying a claim generator and opposing claim generator, in accordance with an embodiment of the present invention.

In one or more embodiments, the claim generator and opposing claim generator 200 can be applied to output a pair of opposing statements about a key phrase.

At block 210, a key word or phrase can be inputted to the claim generator. The key word or phrase, kᵢ, can be selected by a user or determined by the frequency analysis, such as by taking a word or phrase that occurs more frequently in the product's reviews than in the corpus overall.

At block 220, reviews of a product containing the key word or phrase can be inputted to the claim generator. Sentences r⁽¹⁾; . . . ; r⁽ⁿ⁾ containing the key word or phrase are extracted from the product's reviews.

At block 230, the part of speech or type of word or phrase that has been inputted by the user or selected based on frequency can be determined in order to determine which template to apply. Existing systems, such as Spacy, that can label words of sentences with their part of speech can be used. For each part of speech or phrase type, zero or more summary templates, f, can be defined in block 230 for use in block 240. Each summary template, f, quotes the key word or phrase, kᵢ, or a word or phrase derived from kᵢ, and has zero or one positions which are masked and are to be filled in with a word. In one or more embodiments, frequent phrases for the product are used to fill in the templates.

In one or more embodiments, the templates are defined as follows. If kᵢ is a noun or noun phrase, the template is “The kᵢ is [MASK].” If kᵢ is an adjective, the templates are “It is kᵢ.” and “The [MASK] is kᵢ.”

Additional templates may be defined similarly. The templates may involve different words derived from for instance by changing kᵢ from plural to singular if kᵢ is a noun, or by conjugating kᵢ into past tense if kᵢ is a verb. For templates with zero masked positions, an opposing template can be provided by inserting a negation word, such as “It is not kᵢ” for “It is kᵢ,” because the claim generator and opposing claim generator are not used for such templates.

At block 240, for each key word or phrase, k, a summary template, f, is taken, with a slot for the key word or phrase, and zero or one masked tokens to be filled in.

A sequence of tokens, x, can be constructed by concatenating the classification token, each of the sentences, r⁽¹⁾; . . . ; r⁽ⁿ⁾, the separator token, the template output, fⱼ, and another copy of the separator token. The separator token is a special token that tells the model that different sentences have different purposes. The separator token also keeps sentences from being concatenated or mixed up. An input token is part of an input sequence. In one or more embodiments, the claim generator 200 can be trained 300 to complete a template with fluent, logically implied statements.

At block 250, one masked word in the template can be predicted using a refined claim generator, T¹, applied to the input reviews. In this sequence, suppose a mask token appears at position, m, within the template output, fⱼ. Claim generator, T¹, outputs a distribution over words at position m. Let w₁; . . . ; wₛ be the s most probable words, and let g₁; . . . ; gₛ be the claims achieved by substituting into the masked position of template output, fⱼ.

At block 260, substitutions of the predicted words from the claim generator into the template can be reranked using entailment against the review sentences that include the key phrase, where entailment decides whether the completed template is logically implied by each of the review sentences. The average log likelihood of a sentence implying the completed template, output by the entailment module, M, is used for reranking. Then take the word w=wᵢ and claim g=gᵢ that maximizes:

Σⱼ₌₁ⁿM(r^{(j)}, gᵢ, entails).

Given claim g, let y be the sequence of tokens constructed by concatenating the classification token, the sentences, r⁽ⁱ⁾, claim, g, the separator token, the template output f, and another copy of the separator token.

At block 270, one masked word in the template can be predicted using an opposing claim generator, T², applied to y. In this sequence, a mask token appears at position m′. Opposing claim generator, Tₘ², outputs a distribution over words at position m′. Let w′₁; . . . ; w′ₛ be the s most probable words, and let g′₁; . . . ; g′ₛ be the claims achieved by substituting into the masked position off.

At block 280, the predicted words from the opposing claim generator, T², can be reranked using entailment against the reviews, where entailment decides whether the completed template is logically refuted by the statement ranked highest in block 260. The log likelihood of refutation is used for ranking. Take the word w′=w′ᵢ and claim g′=g′ᵢ that maximizes M(g; g′ᵢ; refutes).

At block 290, the highest ranked statement, g, from block 260 and the highest ranked opposing statement, g′, from block 280 can be presented to the user. If the top entailment probability from block 260 is too low, the system/method can end without outputting statements.

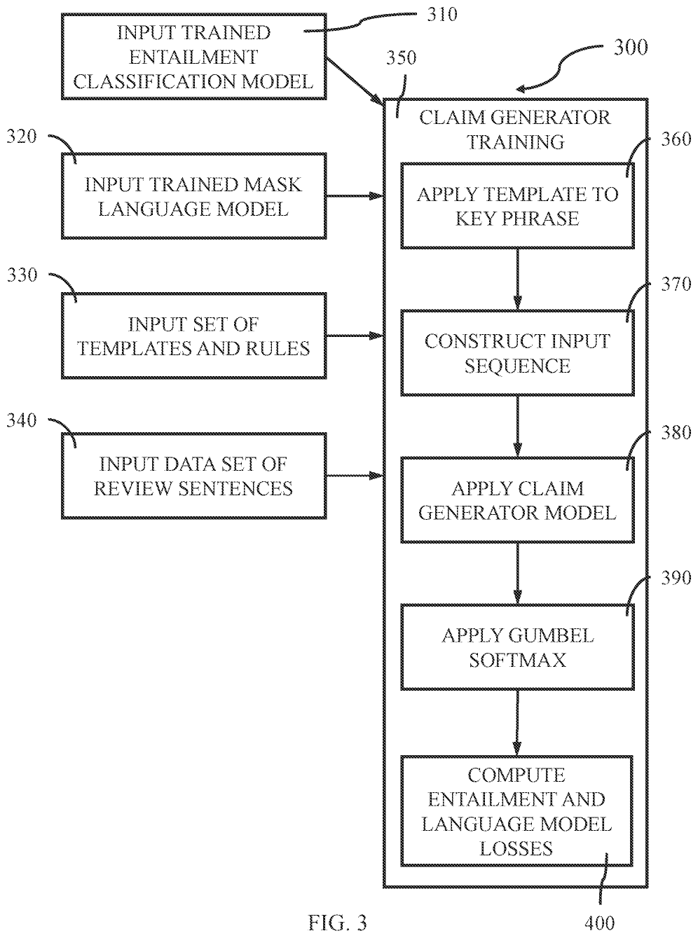

FIG. 3 is a flow diagram illustrating a system/method for training a claim generator, in accordance with an embodiment of the present invention;

In one or more embodiments, the claim generator model 200 can be trained 300 to complete a template with fluent, logically implied statements.

At block 310, a trained entailment classification model, M, can be inputted to the claim generator training method 350.

At block 320, a pretrained masked language model, T⁰, can be inputted to the claim generator training method 350. In one or more embodiments, a pretrained transformer model, T, that has been pretrained for masked language modeling, such as BERT, can be fine-tuned. The vocabulary for such a model includes tokens for common words and pieces of words, and several special tokens used in training, including a classification token and a separator token.

In various embodiments, T⁰, written for the pretrained model can be written before fine-tuning, and T¹ can be written for the fine-tuned model. T⁰ can be used for training, and T¹ can be generated from T⁰ by backpropagation. Given a sequence of tokens, x, at each position, i, T⁰ outputs a distribution Tᵢ⁰ over tokens, v, in a vocabulary, [symbol] , in which Tᵢ⁰(v) predicts:

log P (xᵢ=v|x₋₁);

where x₋ᵢ denotes the sequence where the ith token is masked.

At block 330, a set of templates and rules can be inputted to the claim generator training method 350.

At block 340, a data set of review sentences, where given key phrases occur, can be inputted to the claim generator training method 350. A dataset, [symbol] , is provided in which the i^{th} example consists of a keyword or phrase kᵢ and a set of sentences rᵢ⁽¹⁾; . . . ; rᵢ⁽ⁿ^{ᵢ}⁾, each from a review of the same product and each containing kᵢ.

At block 350, the claim generator training method can receive and implement the inputs. A claim generator model T¹ is finetuned from the pretrained masked language model, T⁰.

At block 360, the claim generator training method 350 can apply one or more templates to a key phrase, kⱼ. Let fⱼ be the output of a summary template on kⱼ. If there is no masked token in fⱼ, this example is not used for training the claim generator model T¹.

At block 370, the claim generator training method 350 can construct an input sequence of words. Construct x^{(j)} for blocks 250 and 370 by concatenating the classification token of the vocabulary of T, each of the sentences, rⱼ^{(k)}, the separator token of the vocabulary of T, the template output fⱼ, and another copy of the separator token. One position xₘ_{ⱼ}^{(j)} is a masked token, coming from inside fⱼ. The separator token is a special token that tells the model that different sentences have different purposes. The separator token also keeps sentences from being concatenated or mixed up. An input token is part of an input sequence.

At block 380, the claim generator training method 350 can apply a claim generator model, T¹, to the input sequence. The claim generator model may be initialized using a copy of the parameters of the pretrained masked language model, T⁰, and then fine-tune its own parameters during the course of the training 300 described in this figure.

At block 390, the claim generator model can apply a Gumbel softmax function to obtain one or more words for the masked position in the input sequence. In various embodiments, a straight through Gumbel softmax estimator, Gτ, with temperature τ is used to obtain a single word, wⱼ=G_{τ}(Tₘ_{ⱼ}¹(x^{(j)})), in such a way that it may backpropagate through G_{τ}. The Gumbel softmax estimator outputs a single choice. Let gⱼ be the result of substituting wⱼ into the masked position of the template output fⱼ.

The Gumbel-Max offers an efficient way of sampling from the probability distribution over subwords (replacement values for the MASK) output by the model T¹ by adding a random variable to the log of the probabilities and taking the argmax. The second step is to replace the argmax with a softmax to make this operation differentiable as well. The softmax here has a temperature parameter τ. Setting τ to 0 makes the distribution identical to the categorical one and the samples are perfectly discrete. For small τ, the gradients have high variance, which is an issue of stochastic neural networks. Therefore, there is a trade-off between variance and bias for Gumbel softmax.

At block 400, an entailment loss can be computed for the claim generator model for the entailment of the completed template against the input sentences and a language modeling loss. In various embodiments, the training method 300 utilizes a trained entailment module, M, where M(p; h; r) predicts the logarithm of the probability that premise p and h are in relation r.

The entailment loss is given by:

$${ℒ}_{1} = - \frac{1}{{n}_{j}} {\sum }_{k = 1}^{{n}_{j}} M ( {r}_{j}^{( k )} , {g}_{j} , entails ) .$$

This refers to sentence number k of the reviews that mention keyword kⱼ.

The entailment loss results from substituting wⱼ into the MASK location. This loss reflects the average log likelihood that each review statement supports the claim gⱼ, according to entailment module, M, which is for entailment/implication. A second loss reflects the word log likelihood estimates according to the language model T⁰:

[symbol]

₂=−Tₘ_{ⱼ}⁰(wⱼ).

The total loss is a linear combination L=λL₁+L₂ of these two losses, where λ is a weight applied to L₁. The loss is calculated from the teacher model in a teacher-student arrangement. Low Log probabilities result in a high loss.

In various embodiments, the loss(es), L, L₁, L₂ can be used for backpropagation to refine the pretrained claim generator model. Training proceeds by backpropagation through M, G_{τ}, and T¹, during which the parameters of entailment module, M, are held fixed. An annealing schedule may be used to lower the temperature τ of the Gumbel softmax.

The trained claim generator model, T¹, can be provided to the user.

In a non-limiting exemplary embodiment, for each part of speech or phrase type, one or more summary templates can be defined in block 330 for use in block 360. Each summary template quotes the key word or phrase, kᵢ, or a word or phrase derived from kᵢ, and has zero or one positions which are masked and are to be filled in with a word.

For example, template, f, can be: “The [KEYWORD] was [MASK].”

Given a KEYWORD of “delivery” and reviews of:

“The delivery was super fast and came in perfect shape.”

“The delivery came on time.”

“Really rapid delivery.”

“Loved the speedy delivery.”

In block 380, the refined claim generator model, T¹, might output: “The delivery was fast,” because it has been trained (in block 400) with a loss from the pretrained language model, T⁰, which finds that “fast” is a fluent completion of the template, and with a loss from the entailment module, M, which finds that this set of sentences entails “The delivery was fast.”

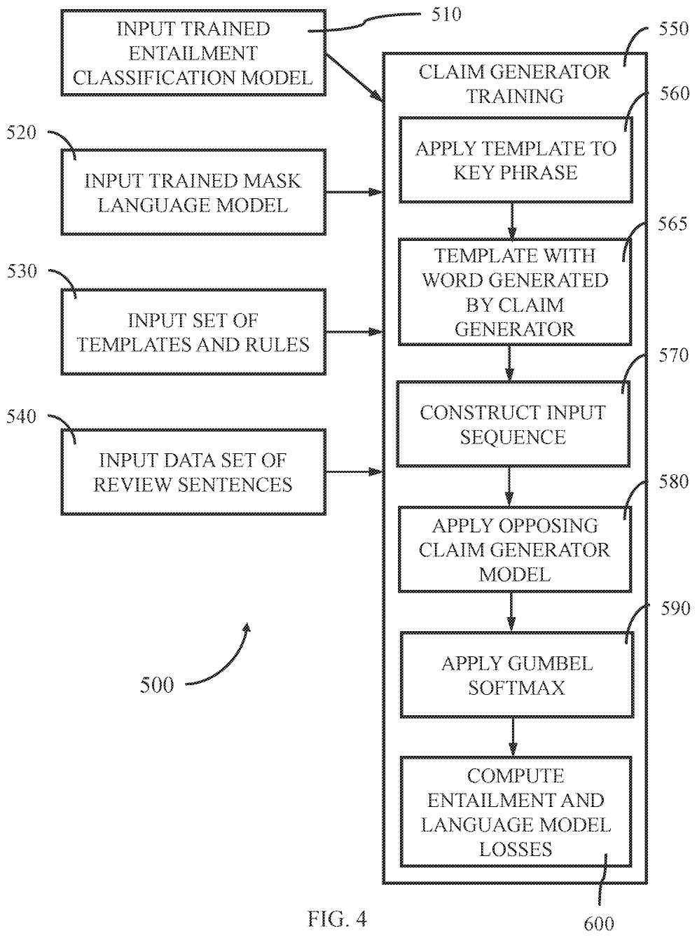

The output would then be: “The delivery was fast.” In various embodiments, T⁰, written for the pretrained model can be written before fine-tuning, and T¹ can be written for the fine-tuned model. T⁰ can be used for training, and T¹ can be generated from T⁰ by backpropagation. For an opposing claim generator, a second model T² can be fine-tuned from T⁰, as shown in FIG. 4.

The refined contrary claim generation model, T², might output: “The delivery is slow,” because “slow” is a fluent completion of the template according to language model T⁰, and the entailment module, M, would find that “The delivery is fast” refutes “The delivery is slow.”

FIG. 4 is a flow diagram illustrating a system/method for training an opposing claim generator, in accordance with an embodiment of the present invention;

In one or more embodiments, the opposing claim generator 200 can be trained 500 to output a best ranked contrary statement from the top predictions from the entailment module. Backpropagation can be used for training the opposing claim generator.

At block 510, a trained entailment classification model can be inputted to the opposing claim generator training method 550.

At block 520, a trained masked language model, T⁰, can be inputted to the opposing claim generator training method 550.

At block 530, a set of templates and rules can be inputted to the opposing claim generator training method 550.

At block 540, a data set of review sentences can be inputted to the opposing claim generator training method 550. A dataset, D, is provided in which the i^{th} example consists of a keyword or phrase kᵢ and a set of sentences rᵢ⁽¹⁾; . . . ; rᵢ⁽ⁿ^{ᵢ}⁾, each from a review of the same product and each containing kᵢ.

At block 550, the opposing claim generator 550 can receive the inputs.

At block 560, the opposing claim generator can apply one or more templates to a key phrase selected by the user or by frequency analysis.

At block 565, the claim generator T¹ is applied to the inputted to the template and the j^{th} example of D to output a sentence gⱼ.

At block 570, the opposing claim generator can construct an input sequence by concatenating the classification token, the sentence gⱼ, the separator token, the template fⱼ, and a second copy of the separator token. Exactly one position m′ⱼ of y^{(j)} is masked.

At block 580, the opposing claim generator can apply an opposing claim generator model, T², to the input sequence. The opposing claim generator model may be initialized using a copy of the parameters of the trained masked language model T⁰and then fine-tune its own parameters during the course of the training described in this figure.

At block 590, the opposing claim generator can apply a Gumbel softmax function to the obtain one or more words for the masked position. A single word w′ⱼ=G_{τ}(T_{m′}_{ⱼ}²(y^{(j)})) is obtained from the straight through Gumbel softmax estimator G_{τ} applied to T² at position m′ⱼ.

Let g′ⱼ be the result of substituting w′ⱼ into the masked position of the template output fⱼ.

The refined contrary language model, T², might output: “The delivery is slow,” because “slow” is a fluent completion of the template according to language model T⁰, and the entailment module, M, would find that “The delivery is fast” refutes “The delivery is slow.”

At block 600, the opposing claim generator can compute a loss for the refutation of the completed template by the output of the claim generator model, and a language modeling loss. Define the loss:

[symbol]

₃=−M(gⱼ, g′ⱼ),refutes);

In various embodiments, the loss(es) can be used for backpropagation to refine the opposing claim generator model.

w′ⱼ=G_{τ}(T_{m′}_{ⱼ}²(y^{(j)})).

[symbol]

₃=−M(gⱼ, g′ⱼ), refutes);

reflecting the log likelihood that g′ⱼ contradicts gⱼ. As before, define a second loss using the language model T⁰.

[symbol]

₄=−T_{m′}_{ⱼ}⁰(w′ⱼ).

The total loss for training T² is the linear combination L=λL₃+L₄ of these two losses. The loss(es) can be used for backpropagation through M, G_{τ}, and T² with respect to y^{(j)}, during which the parameters of M are held fixed and the temperature τ may be annealed.

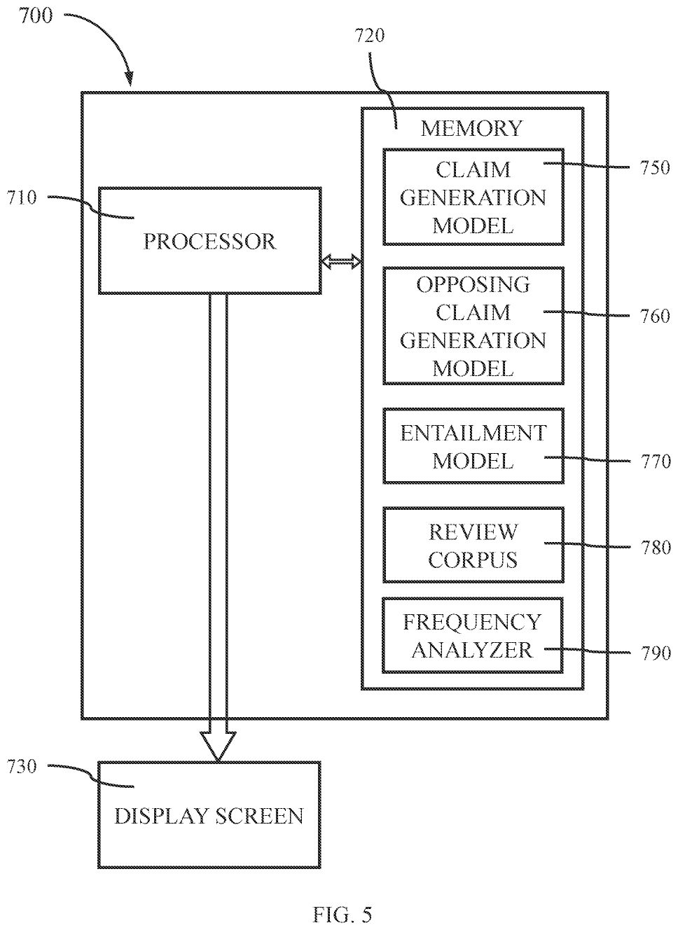

FIG. 5 illustrates a computer system for opinion summarization, in accordance with an embodiment of the present invention.

In one or more embodiments, the computer matching system for opinion summarization 700 can include one or more processors 710, which can be central processing units (CPUs), graphics processing units (GPUs), and combinations thereof, and a computer memory 720 in electronic communication with the one or more processors 710, where the computer memory 720 can be random access memory (RAM), solid state drives (SSDs), hard disk drives (HDDs), optical disk drives (ODD), etc. The memory 720 can be configured to store the opinion summarization tool 100, including a trained claim generator model 750, trained opposing claim generator model 760, trained entailment model 770, and review corpus 780. The trained claim generator model 750 can be a neural network configured to generate claims utilizing one or more templates. The opposing claim generator model 760 can be a neural network configured to generate opposing claims utilizing one or more templates. The entailment model 770 can be configured to calculate entailment and entailment loss for each of the claims generated by the claim generator model 750 or opposing claims generated by the opposing claim generator model 760. A display module can be configured to present an ordered list of the claims and opposing claims to a user as a summary of the reviews. The memory 720 and one or more processors 710 can be in electronic communication with a display screen 730 over a system bus and I/O controllers, where the display screen 730 can present the ranked list of claims.

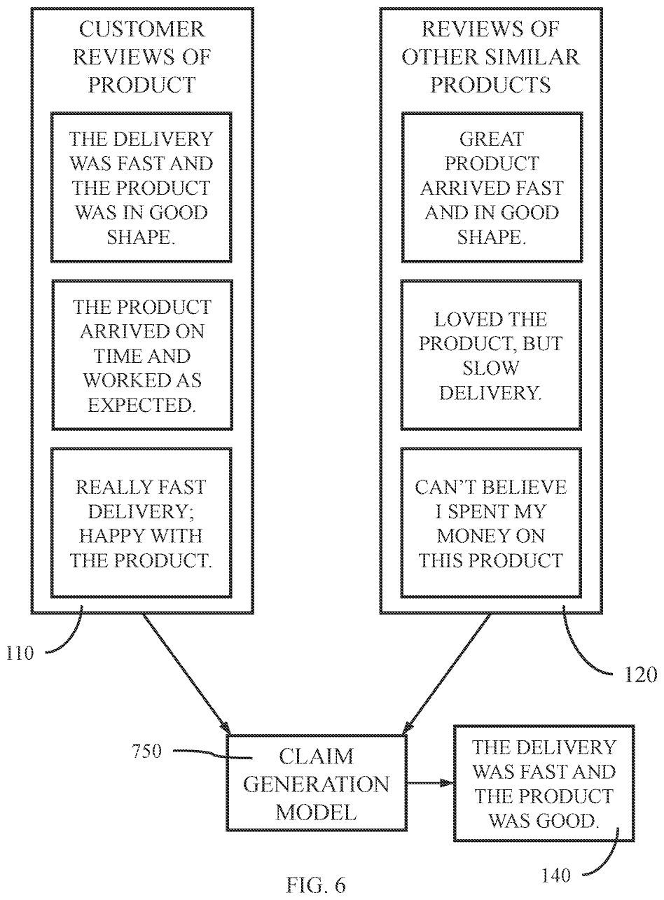

FIG. 6 is a block diagram of exemplary reviews and output, in accordance with an embodiment of the present invention.

In one or more embodiments, a list of reviews of a single product 110 can be fed into the system/method. The list of reviews of a single product 110 can include a number of different statements regarding the particular product (or service) provided by customers of the product (or service). A corpus of reviews of similar products (or services) 120 can be fed into the system/method. The list of reviews can include a number of different statements regarding products (or services) that are similar to the product of service being reviewed. The trained neural network claim generator model 750 can be a neural network configured to generate claims utilizing one or more templates. A claim generated by the claim generator model 750 that summarizes the input claims can be output 140. An opposing claim generated by the opposing claim generator model can also be output to form a pair of opposing claims.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for extracting and counting frequent opinions, comprising:
performing a frequency analysis on an inputted list of product reviews for a single item and an inputted corpus of reviews for a product category containing the single item to identify one or more frequent phrases;
fine tuning a pretrained transformer model to produce a trained neural network claim generator model, T¹;
generating a trained neural network opposing claim generator model based on the trained neural network claim generator model;
generating a pair of opposing claims for each of the one or more frequent phrases related to the product review using the trained neural network claim generator model and the trained neural network opposing claim generator model, wherein a generated positive claim is entailed by the product reviews for the single item and a negative claim refutes the positive claim; and
outputting a count of sentences entailing the positive claim and a count of sentences entailing the negative claim.

2. The method as recited in claim 1, wherein the trained neural network claim generator model, T¹, is trained utilizing a loss measuring whether the generated text is entailed by the product reviews.

3. The method as recited in claim 2, wherein the pretrained transformer model is a Bidirectional Encoder Representations from Transformers (BERT).

4. The method as recited in claim 2, wherein the trained neural network claim generator model, T¹, is trained utilizing a loss measuring whether the generated text is fluent according to the pre-trained language model.

5. The method as recited in claim 2, wherein the positive claim is generated by the substitution of words from the trained neural network claim generator model, T¹, into a template.

6. The method as recited in claim 5, wherein the substitution words are predicted by a Gumbel softmax function, and the words are reranked using entailment against the review sentences.

7. A computer system for opinion summarization, comprising:
one or more processors;
computer memory; and
a display screen in electronic communication with the computer memory and the one or more processors;
wherein the computer memory includes a frequency analyzer configured to perform a frequency analysis on an inputted list of product reviews for a single item and an inputted corpus of reviews for a product category containing the single item to identify one or more frequent phrases;
a trained neural network claim generator model;
a trained neural network opposing claim generator model, wherein the trained neural network claim generator model and the trained neural network opposing claim generator model are configured to generate a pair of opposing claims for each of the one or more frequent phrases related to the product reviews, wherein a positive claim generated by the trained neural network claim generator is entailed by the product reviews for the single item and a negative claim generated by the trained neural network opposing claim generator refutes the positive claim, and
an entailment module configured to output a count of sentences entailing the positive claim and a count of sentences entailing the negative claim.

8. The computer system as recited in claim 7, wherein the positive claim is generated by the claim generator based on a first fine-tuned pretrained transformer model, T¹.

9. The computer system as recited in claim 8, wherein the first pretrained transformer model is a Bidirectional Encoder Representations from Transformers (BERT).

10. The computer system as recited in claim 8, wherein the negative claim is generated by the opposing claim generator based on a second fine-tuned pretrained transformer model, T².

11. The computer system as recited in claim 10, wherein the second pretrained transformer model is a BERT.

12. The computer system as recited in claim 8, wherein the claim generator model is configured to generate the positive claim by the substitution of words into a template.

13. The computer system as recited in claim 12, wherein the substitution words are predicted by a Gumbel softmax function, and the words are reranked using entailment against the review sentences.

14. A non-transitory computer readable storage medium comprising a computer readable program for extracting and counting frequent opinions, wherein the computer readable program when executed on a computer causes the computer to perform the steps of:
performing a frequency analysis on an inputted list of product reviews for a single item and an inputted corpus of reviews for a product category containing the single item to identify one or more frequent phrases; fine tuning a pretrained transformer model to produce a trained neural network claim generator model, T¹;
generating a trained neural network opposing claim generator model based on the trained neural network claim generator model;
generating a pair of opposing claims for each of the one or more frequent phrases related to the product review using the trained neural network claim generator model and the trained neural network opposing claim generator model, wherein a generated positive claim is entailed by the product reviews for the single item and a negative claim refutes the positive claim; and
outputting a count of sentences entailing the positive claim and a count of sentences entailing the negative claim.

15. The non-transitory computer readable storage medium comprising a computer readable program, as recited in claim 14, wherein the trained neural network claim generator model, T¹, is trained utilizing a loss measuring whether the generated text is entailed by the product reviews.

16. The non-transitory computer readable storage medium comprising a computer readable program, as recited in claim 15, wherein the pretrained transformer model is a Bidirectional Encoder Representations from Transformers (BERT).

17. The non-transitory computer readable storage medium comprising a computer readable program, as recited in claim 15, wherein the trained neural network claim generator model, T¹, is trained utilizing a loss measuring whether the generated text is fluent according to the pre-trained language model.

18. The non-transitory computer readable storage medium comprising a computer readable program, as recited in claim 17, wherein the positive claim is generated by the substitution of words from the trained neural network claim generator model, T¹, into a template.

19. The non-transitory computer readable storage medium comprising a computer readable program, as recited in claim 18, wherein the substitution words are predicted by a Gumbel softmax function, and the words are reranked using entailment against the review sentences.
